(19) United States
(12) Patent Application Publication
(10) Pub. No.: US 2018/0087886 A1
(43) Pub. Date: Mar. 29, 2018

(54) METHOD AND APPARATUS FOR MEASURING THE THICKNESS OF A WALL OF A CONTAINER SUCH AS A YOGHURT CUP

(71) Applicant: COMPAGNIE GERVAIS DANONE, Paris (FR)

(72) Inventors: Cedric BEAL, Messery (FR); Pascal PROVENAZ, Thonon Les Bains (FR)

(21) Appl. No.: 15/562,178

(22) PCT Filed: Mar. 24, 2016
(86) PCT No.: PCT/FR2016/050649

§ 371 Date: Sep. 27, 2017

(30) Foreign Application Priority Data
Mar. 27, 2015 (FR) 15 52597

(51) Int. Cl. G01B 5/06; G01B 5/00

(52) U.S. Cl. CPC G01B 5/06; G01B 5/0004

(57) ABSTRACT

Disclosed is a method that enables measurement of several thicknesses in a section to be inspected of a hollow container with an axial opening, such as a thin-walled yogurt pot. After having inserted the container through its opening onto a contact support and loaded the container in a predetermined space bordered by a position detection unit, thicknesses are determined by using several mobile support members which are each guided by a set orientation guide. The members are slid into the guide, either up to a first contact defined by a stopper in a calibration configuration without the container, or up to a second contact surface defined by the hollow container in an actual measurement configuration, the movement of these members being automatically controlled by a control unit.

### TECHNICAL FIELD OF THE INVENTION

This invention relates to the field of containers with a thin, typically flexible wall, which are produced for mass consumption applications. More specifically, it relates to a method and an equipment for measuring the thickness of a wall of a hollow container such as a yogurt pot. The invention also relates to a method of manufacturing hollow containers with a control using the method for measuring thickness.

### TECHNOLOGICAL BACKGROUND OF THE INVENTION

There are thin-walled containers, particularly in the agribusiness field, for example, for the packaging of dairy products or other food products (solids, liquids or semi-liquids). Such containers can have a bottom, preferably forming a flat base and a lateral wall which extends longitudinally from the bottom up to an axial opening, allowing the content to be accessed. For thin-walled containers, when the thickness can be non-destructively and effectively measured, risks of loss and contamination of the container to be minimised. Containers, in particular thermoformed pots, can be subject to transportation constraints (for example, palette packaging with the need for sufficient resistance to vertical compression) and too much reduction in thickness in the body of the hollow container generally causes problems: either during transportation to the shop, or during handling by the consumer.

More generally, it is useful to be able to control the distribution of thicknesses of a hollow container, which can allow the quality of this container to be guaranteed. The use of thin walls, with thicknesses typically less than 0.5 mm, and preferably less than or equal to 0.25 mm, allows material saving. With a material stretched by thermoforming, it is understood that a lateral wall of such a container has certain flexibility at least radially.

It is known that methods for measuring the thickness by using optical sensors allow measurements to be taken without contact. If such methods offer good precision, they have a reduced scope, as they are unsuitable for opaque bodies.

Also, methods for measuring the thickness on one single side are known (unilateral measuring method) which use a capacitive sensor. Using a capacitive sensor however has a lack of flexibility, as the material(s) constituting the container to be inspected can vary. Furthermore, the measurement must be taken in a dry environment.

A bilateral measuring method is known, by the document U.S. Pat. No. 6,860,025, to determine the thickness of a tubular wall of a necked container. The equipment used takes a measurement (in practice, clearly with the container in a non-filled state) between a mobile rod, of which the end contacts the outside of the tubular wall and a top opposite, inserted against the internal face of the tubular wall. The mobile rod must be pre-positioned by the operator to be aligned with the tip. Then, a first forward position of the rod contacting against the tip is detected in a calibration configuration (without the container), then a second forward position contacting against the wall of the container is detected in an actual measurement configuration.

With this type of equipment, it is not permitted to quickly collect several measurements of thickness in areas separate from the inspected container. In particular, adjustments by an operator are necessary to be able to accumulate measurements in several areas corresponding to different height levels of the container.

Moreover, the equipment used according to the document U.S. Pat. No. 6,860,025 requires manual interventions which, inherently, cause difficulties for repeatability of the measurements (with a significant risk of deviation in measuring one production factory against another). In particular, it is the case when the material of the hollow container to inspect has a certain flexibility. Consequently, the equipment shown in the document U.S. Pat. No. 6,860,025 only appears adapted for the inspection of glass bottles or possibly plastic bottles with a rigid wall, which is generally thick.

Therefore, there is a need for an effective thickness measuring method, reducing manual interventions likely to alter the repeatability of measurements.

### GENERAL DESCRIPTION OF THE INVENTION

This invention aims to compensate for one or several of the disadvantages encountered in the prior art.

To this end, it is proposed, according to the invention, a method for measuring the thickness in at least one section to be inspected of a body of a hollow container (intended to be filled with a content), such as a thin-walled yogurt pot, the body defining an internal volume leading to an axial opening, the method comprising the following steps:
recovery of a hollow container (for example, during a method of manufacturing a plurality of hollow containers), the body of the recovered hollow container comprising a bottom opposite the axial opening and defining a lateral wall which extends around the longitudinal axis;
contacting the bottom and/or internal face of the lateral wall with a contact support (which fills all or part of the internal volume);
determining a thickness respectively in N separate areas, which are part of the section to inspect, by using N mobile support members which are each guided by a set orientation guide positioned in one among the contact support and an exterior coverage structure covering the hollow container, the N mobile support members each being moved by sliding in the guide towards:
   i) a first contact surface, defined by a stopper intended to contact with the body of the hollow container, in a calibration configuration without hollow container obtained before or after the contacting step, which allows a first forward position of the mobile support member in question to be detected;
   ii) a second contact surface defined by the body of the hollow container, in an actual measurement configuration when the body of the hollow container is contacting the contact support, preferably by nesting, which allows a second forward position of the mobile support member in question to be detected, the second forward position being representative of a thickness of the body of the hollow container when compared with the first forward position;
control (in particular, automatic control) of the movement of the N mobile support members by a control unit, N being an integer higher than or possibly equal to two.

Using these provisions, the measurement can be taken effectively and quickly (for example, to qualify a production line of hollow containers). The pre-positioning of guides (which have a set orientation) allows uncertainties connected to human intervention to position the sensor, to be avoided.

When the container has an opening (typically single) as wide as the widest section of the tubular wall, the contact support can define a plurality of stationary stoppers, advantageously serving to form the first respective contact surfaces, whereon the following come into abutment with:
mobile support members in the calibration configuration on the one hand; and
the internal face (preferably supported by both the bottom and the lateral wall) of the body of the hollow container in the actual measurement configuration on the other hand.

In this case, the contact support defines a standard with the dimensions corresponding with the internal face of the body of the hollow container, at least in the section to be inspected.

Alternatively, when the container has a widened section compared with the axial opening (typically forming the single opening of the container), the contact support can comprise all or part of the mobile support members, whereas the coverage structure is configured to define all or part of the stoppers forming the first respective contact surfaces.

Using a control which can be a common control (control typically automatic) and an attached guiding unit to move the mobile support members, the movements are realized without any significant error or deviation. If the use of calibration is added to that, it is understood that the measuring method has very good repeatability, typically with a standard deviation which can be less than 5 μm.

In the preferred embodiments of the method according to the invention, one or more of the following provisions may possibly be used:
the N mobile support members are each moved under the effect of a pressurised fluid, each exerting on the body of the container a contact force regulated by an elastic return member and/or a device for regulating the pressurising of the pressurised fluid; this regulation is advantageous to avoid the support being made with a contact force higher than a threshold which enables the flattening of the inspected section of wall, in particular when the section to inspect is made from a flexible material.
the hollow container has no neck and has a height measured longitudinally between the bottom and a top end, measurements of thickness of the hollow container being made at different height levels, by all or part of the N mobile support members, N being able to be an integer, optionally higher than or equal to five or six (therefore, at least five measurements of thickness can automatically be recovered, which can already give a good representation of a thickness profile of the body following a longitudinal section).
the different height levels can be spaced out from a longitudinal distance (measured parallel to the longitudinal axis) less than or equal to 20 mm and preferably less than 15 mm; thus, measurements of thicknesses that are sufficiently close are obtained so as to adequately reflect the distribution, according to the longitudinal axis, of thicknesses of the hollow container. As a non-exhaustive example, the longitudinal distance between two successive height levels of measurement can be more than or equal to 5 mm.
a first phase of detection of the second forward position is made simultaneously for at least two areas belonging to the bottom, by simultaneously moving at least two first mobile support members from the N mobile support members (this allows several areas of the bottom to be inspected particularly quickly, without moving the contact support or the coverage structure).
mobile support members among the N mobile support members, separate from the first mobile support members, are moved to carry out at least one other detection phase of the second forward position for one or several areas belonging to the lateral wall (this also enables the lateral wall to be inspected without handling the hollow container or moving an element of the measuring equipment).
at least one of the N mobile support members is moved with a time difference in relation to the movement of the first mobile support members (with this provision, the different area(s) inspected are reduced or the possible interactions which could falsify the measurement are thus minimised).
a second detection phase of the second forward position is carried out simultaneously for two areas close to the bottom which are part of the lateral wall and located nearer the bottom than the axial opening, by simultaneously moving two mobile support members from the N mobile support members.
a third detection phase of said second forward position is carried out simultaneously for at least two areas separate from the bottom which are part of the lateral wall and preferably located nearer the axial opening than the bottom, by simultaneously moving at least two third mobile support members from the N mobile support members.
the first detection phase, the second detection phase and the third detection phase are activated automatically by one single command (with such movements initiated by one single command, measurements spread out at different height levels are quickly obtained, without the least ergonomic difficulty for the user who has no intermediate intervention to do provided that the actual measurement configuration is maintained).
at least one step of the manufacturing method is modified when the second forward position is representative of a thickness of the body of the hollow container, which is less than a thickness threshold predefined for the manufacturing method (as the measurement results can be collected quickly, the modification of the manufacturing method is accelerated and the possible rejections of containers are minimised).

Another aim of the invention is to propose a manufacturing method with an improved quality control.

To this end, a method for manufacturing hollow containers provided with a body intended to be filled by a content is proposed, for example, thermoformed pots, comprising a step for forming the body by defining an internal volume leading to an axial opening, and wherein measurements of the thickness of the body are made in different areas of the body by following the method for measuring the thickness according to the invention.

According to a particular, the manufacturing method comprises:
a step for recovering a hollow container after the forming step;
a step for inspecting a hollow container recovered during which measurements of thickness are taken, comprising a control of the measurements of thickness according to one or several predefined thresholds;
when at least one measured thickness of the body recovered is outside of a range limited by the said threshold(s), a step for adjusting the forming step and/or a step prior to the forming step in order to manufacture hollow containers, of which the body has at least one thickness modified as compared to the body of the recovered container.

The optimisation of the current production method thus becomes possible, in particular by reducing the measuring time (compared with a method with sequential measurements using a thickness measurement gauge, requiring an adjustment by the operator to each bilateral measurement). It is understood that the manual interventions of the operator are reduced to the minimum.

The opening section of the containers is as wide or wider than a section of the body, the containers preferably being provided without a neck (on the one hand, to limit their height, and on the other hand, to simplify and make the attachment of the closing part quicker). Of course, the term “section” must be understood as a section obtained in a cross-section plane (horizontal plane when the container is elevated vertically), as this is usual in the field in question here.

The manufacturing method with forming can be an FFS type or using a technology (of “open mould” type) at opening the mould at the time of the mould release.

The invention also aims to obtain a thickness measuring equipment, particularly well adapted for quickly recovering information representative of the distribution of thicknesses in the body of a hollow container, with the measurements being satisfactorily precise.

To this end, a thickness measuring equipment is proposed for the implementation of the method according to the invention, enabling measurements of thickness of a hollow container that has a body with a determined format provided with a bottom and a lateral wall, the equipment comprising:
a contact support (of which the external dimensions correspond with the determined format of the body) intended to be inserted into the internal volume of the hollow container, the contact support having a free end; and
a position detection unit comprising at least one mobile support member which is:
   i) mobile up to a first forward position defined by a stopper in a calibration configuration of the measuring equipment; and
   ii) adapted to abut/bear, in an actual measurement configuration of the measuring equipment, against the body of the hollow container, in a way to define a second forward position representative of a thickness of the body of the hollow container when compared with the first forward position;
a coverage structure (fully extending outside of the hollow container in the actual measurement configuration) which defines, with the contact support, a predetermined space in the calibration configuration and the actual measurement configuration, this predetermined space being intended to receive a section to be inspected of the body of the hollow container, in the actual measurement configuration when the body of the hollow container is inserted onto the contact support, the position detection unit comprising:
N mobile support members, each guided by a set orientation guide positioned in one among the contact support and the coverage structure, each one of the N support members being slid into the guide towards to predetermined space in the calibration configuration and in the actual measurement configuration.

According to a particular, the detection unit further comprises:
N stoppers corresponding to the path of said N mobile support members to respectively define said first forward position; and
a control unit to control (preferably automatically) the movement of N mobile support members, N being an integer higher than or equal to two.

Thus, ergonomic measuring equipment is obtained, and of which complementarity between the coverage structure and the contact support enabling several areas of measuring thickness to be pre-positioned.

In the preferred embodiments of the measuring equipment according to the invention, one or more of the following provisions may possibly be used:
one of the N mobile support members is positioned at a greater distance from the free end of the contact support than another of the N mobile support members.
the coverage structure has a first face which extends parallel to a first plane to receive an external face of the bottom and a second face which extends from an end close to or connected to the first face up to a section distant from the first plane.
at least one determined support member from the mobile support members is configured to slide along a direction perpendicular to the first plane and to enable a measurement of the thickness of the bottom of the body, the free end of the contact support having a determined stopper, among the N stoppers, which corresponds to the path of the determined support member to define the first forward position of the determined support member.
at least two of the N stoppers are static/stationary and pre-positioned according to the determined format of the body of the hollow container, so that each one of these two stoppers form a support located in said section to inspect (this enables a standard to be defined, with a stopper profile which corresponds to the profile of the internal face of the section to inspect).
the contact support can hold the static stoppers or the mobile support members.
the equipment comprises a mounting interface, provided with a stopper body and connected to the coverage structure, the mounting interface being configured to move the contact support, preferably by the intermediary of a sliding drawer, between a position distant from the coverage structure and a proximal position, wherein the contact support is blocked by the stopper body, the calibration configuration and the actual measurement configuration being obtained when the contact support is in the proximal position (using such a mounting interface minimises handling of the container).
the N mobile support members are spread out in one same longitudinal plane, parallel to a longitudinal axis of the hollow container in the actual measurement configuration.
when the hollow container has a rotational symmetry and/or identical generating lines on several sections that are angularly offset, the contact support can be mounted freely rotatable, so that several series of measurements can be realized in at least two angularly spaced away sections to be inspected, having same longitudinal profile (if necessary, the number of static stoppers can thus be higher than the number of mobile support members, for example 2N, 3N or 4N if one, two or three respective rotations of 90° are provided); preferably, the contact support can be positioned on a mobile drawer to move the contact support away from the coverage structure, the rotation of the support thus being able to be made before repositioning the contact support in one among the calibration configuration and the actual measurement configuration (this provision enables the number of sensors to be minimised and/or to not increase the number of mobile support members; information representative of the angular position of the contact support can be transmitted to the control unit to distinguish the measurements and thus identify each studied area in the sections to inspect).
the control unit is configured to simultaneously control the movement of at least two of the N mobile support members, respectively in the calibration configuration and in the actual measurement configuration.
the hollow container has an annular collar connected to the body and defining four sides, the mounting interface having at least two elements for guiding into position, to guide at least two opposite sides of the four sides of the collar (this arrangement enables a perfect positioning of the hollow container in relation to the contact support and/or the coverage structure to be ensured).
each one of the N mobile support members comprises a measuring rod, typically biased by an elastic return member towards a set-back position and slidably mounted in a guide in communication with a pneumatic pressure source controlled by the control unit (using a sensor, of which the mobile part is moved against an elastic return force, for example, exerted by a functionally-similar bellow or spring, one can effectively prevent the wall to be inspected from being flattened locally, the contact force being possibly adjusted by appropriately regulating the pressure used for the movement of the mobile support member).
each set orientation guide is mounted in the coverage structure which forms an arch. With this provision, when the coverage structure is static, it is easy to guide the container (for example, with guiding surfaces corresponding to the format of a collar or other external surface defined by the container) and to lock the position of the contact support under the structure (for example, by blocking a loading device that holds the contact support against a jamb of the arch).

### BRIEF DESCRIPTION OF THE DRAWINGS

Other characteristics and advantages of the invention will appear during the following description of several embodiments, given as non-exhaustive examples, in view of the attached drawings, wherein:

FIG. 1 is a schematic view of an equipment for measuring thicknesses in accordance with the invention;

FIG. 2 illustrates the arrangement of a section of container to be inspected, with a measured area positioned between a stopper and a support member that can be moved up to a forward position, representative of the thickness;

FIGS. 3A and 3B respectively illustrate two different contact support examples, which could be used for the implementation of the method for measuring thicknesses according to the invention;

FIG. 4 shows a flowchart illustrating an example of using the method for measuring thicknesses during production;

FIG. 5 is a perspective view illustrating a position, distant from the contact support in relation to the coverage structure, enabling the positioning of the hollow container;

FIG. 6 is a side view illustrating the calibration configuration, with calibration of a part of the sensors.

### DESCRIPTION OF PREFERRED EMBODIMENTS OF THE INVENTION

In the different figures, the identical references indicate identical or similar elements.

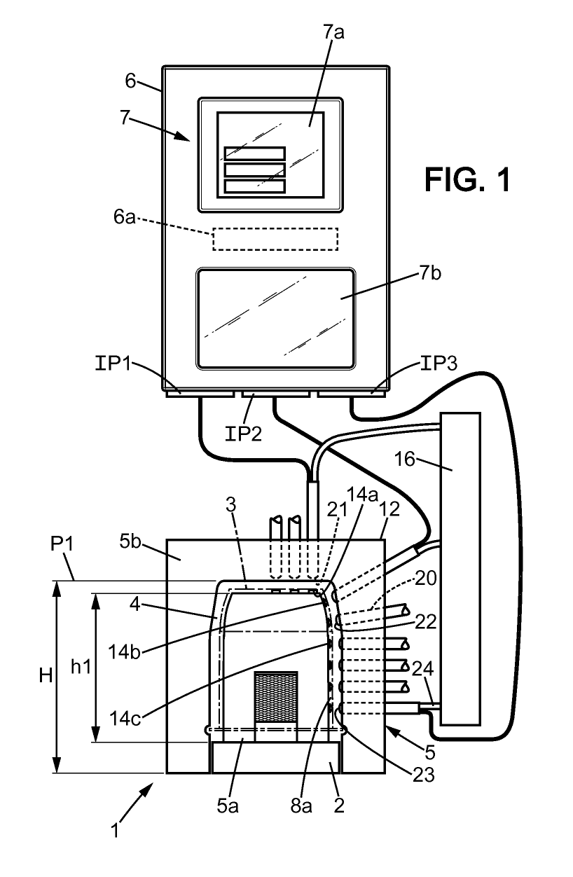

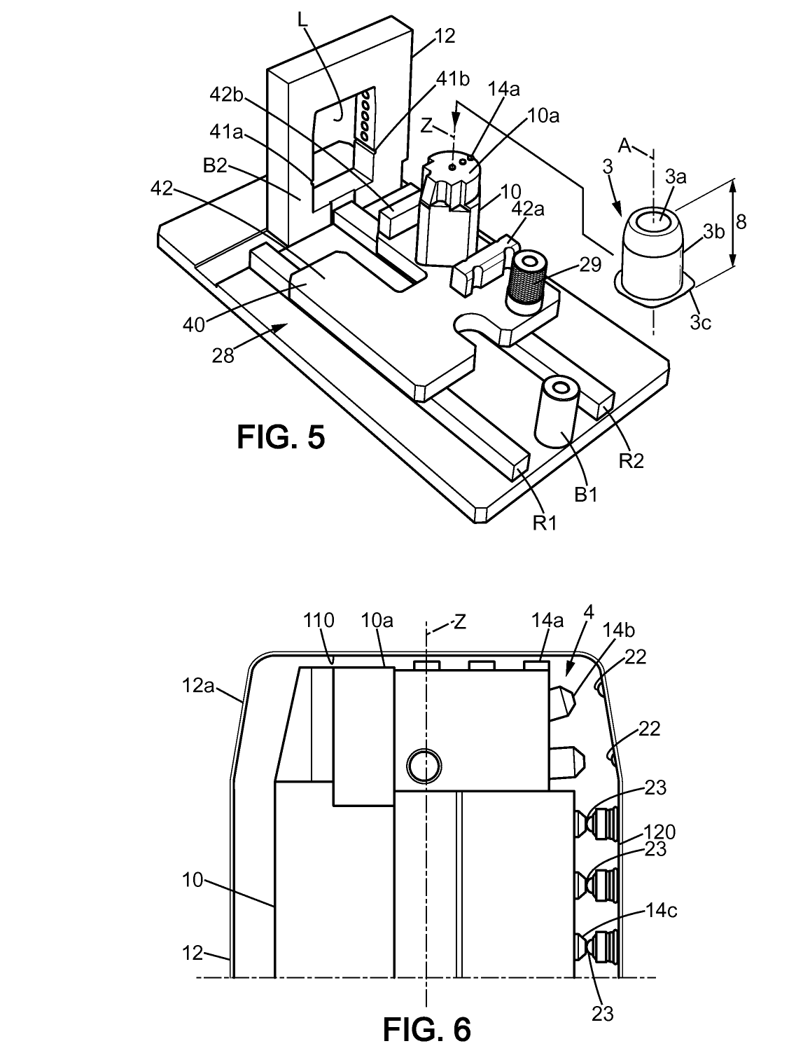

In reference to FIGS. 1 and 5, the equipment 1 for measuring thicknesses has a loading device 2 to load a hollow container 3 in a predetermined space 4 formed between two parts 5a, 5b of a position detection unit 5. The hollow container 3 has a body 8 with a determined format, defining an internal volume. This internal volume enables, for example, to receive a content poured on a bottom 3a and held in the internal volume by a lateral wall 3b, which is typically liquid-tight.

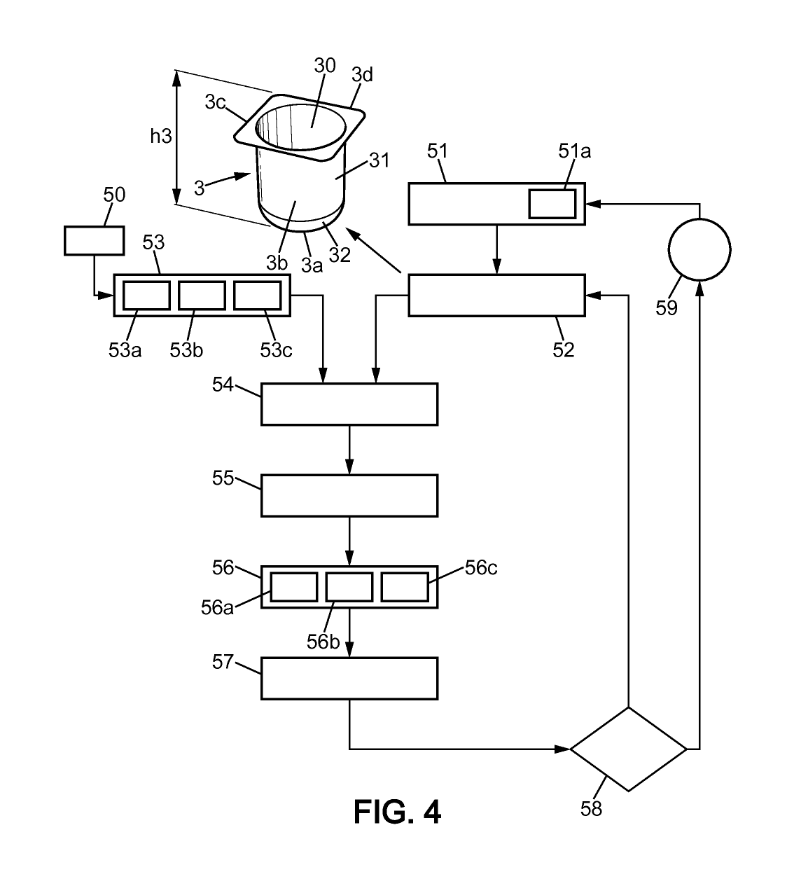

When the hollow container 3 defines a yogurt pot, it can also have an annular collar 3c which extends around an axial opening 30 of the hollow container 3, which can be seen in FIG. 4. The hollow container 3 is thus of the type that has no neck, with a wide section opening, that typically has a diameter Dint of more than 40 mm, preferably more than or equal to 45 mm. Having a sufficiently wide opening is important for the speed of filling yogurt pots and to enable the food content to be easily recovered with a spoon. The hollow container 3 is made of a plastic material which can be in contact with a food product, in particular a dairy product.

In a preferred embodiment, a same sheet of plastic defines the material to form the bottom 3a, the lateral wall 3b and the collar 3c. Only the collar 3c has a thickness (substantially constant) that is equal to the thickness of the sheet of plastic.

More generally, the hollow container 3 can correspond to any type of container, recovered, for example, in the form of a sample lifted from a production line.

A control unit 6, which here has a user interface 7 with, for example, a control touchscreen 7a and a display screen 7b enabling the results to be viewed, is connected to the position detection unit 5. The control unit 6 is configured to automatically control the position detection unit 5 and to collect position measurement data. The control unit 6 can have at least one management module 6a for the unit 5, adapted for receiving user commands coming from the user interface 7. Of course, the control unit 6 can be presented in any other adapted form, if necessary, with a keyboard, a mouse, a remote-control terminal or any other control body. Thus, the term “automatic” does not mean that there is no human intervention possible during a cycle of detecting the position of sensors (for example, one or several interventions via a human-machine interface). Here, this term serves rather to indicate that the detection method for determining thickness is insensitive to the human risk (typically, no handling, which would falsify the detection or would make measurements difficult to repeat).

In the embodiment represented in FIGS. 1, 3A and 5, the body 8 of the hollow container 3 is positioned on a contact support 10, intended to be inserted into the internal volume of the hollow container 3. This contact support 10 thus defines an insertion projection of the unit 5 in the internal volume of the container 3. The free end 10a of the contact support 10 is, for example, in contact with one or several internal surface areas of the bottom 3a, when the body 8 has been positioned. The contact support 10 belongs to a first part 5a of the position detection unit 5.

The sensors are spread out in the position detection unit 5, preferably in the second part 5b of the unit 5. Here, this second part 5b is in the form of an arch and is part of a coverage structure 12, which covers, by the outside, a section to inspect 8a of the body 8 of the hollow container 3, when the equipment is in the actual measurement configuration as illustrated in FIG. 1.

The position detection unit 5 comprises several sensors which here are activated by a thrust, for example, nine sensors. The thrust is typically pneumatic, but other movement solutions (spring thrust, in particular) can be used in variants of the embodiment. For each sensor, a stopper 14a, 14b, 14c is provided, here static, which support one side of the section to inspect 8a and a mobile support member 21, 22, 23, sliding into a set orientation guide 20. Each guide 20 can be mounted fixedly in the coverage structure 12.

The mobile support members 21, 22, 23 are optionally spread out in one same longitudinal plane, parallel to a longitudinal axis Z of the contact support 10, knowing that this longitudinal axis Z can substantially wedge with the longitudinal axis A of the hollow container 3 in the actual measurement configuration. This provision enables measurements of thickness to be collected according to a distribution in the longitudinal direction, which is particularly useful to consider an abnormal difference in thickness which can make the hollow container 3 less resistant to a vertical compression load.

The control unit 6 can be connected to a valve block 16 or similar actuation means, to enable a thrust force to be delivered onto the parts of sensors mounted sliding into the guides 20 and thus move the mobile support members 21, 22, 23. The position detection unit 5 enables to define at least one predetermined space 4 when the loading device 2 is in an insertion position with the coverage structure 12 or a similar, predefined similar proximal position in relation to the coverage structure 12. The section(s) to be inspected 8a extend into such a predetermined space 4, in an actual measurement configuration of the equipment 1.

Referring to FIG. 6, a calibration configuration is represented. This calibration configuration differs from the actual measurement configuration represented in FIG. 1, particularly in that the hollow container 3 has not been loaded. However, the contact support 10 occupies the same place as in the actual measurement configuration, and can constitute a standard using the stoppers 14a, 14b, 14c. In variants of the embodiment, other series of stoppers can be provided on the contact support 10, which can enable more measurements to be obtained, possibly without increasing the number of mobile support members 21, 22, 23 when a predefined pivoting of the contact support 10 is permitted (the container 3 being connected in a rotationally secure manner to this contact support 10).

The calibration configuration is typically obtained after the blocking of the loading device 2 in its insertion position and/or proximal position relative to the coverage structure 12. The predetermined space 4 thus extends between an internal face 12a (or optionally, several spaced out internal faces) of the coverage structure 12 and the contact support 10. When the coverage structure 12 defines an arch, all or part of the free end 10a of the contact support 10 can extend under the arch. It is understood that the predetermined space 4 is thus bordered (over two opposite sides) by the additional parts 5a and 5b of the position detection unit 5.

When the thicknesses both for the bottom 3a and the lateral wall 3b are wanted to be measured, the coverage structure 12 can have a first face 110 which extends parallel to a first plane P1 to cover an external face of the bottom 3a and a second face 120 which extends up to a section distant from the first plane P1. In the example illustrated in FIG. 1, the mobile support member(s) 21 provided for support against the bottom 3a are moved according to a longitudinal direction, perpendicular to the first plane P1. The corresponding stopper(s) 14a can define all or part of the free end 10a of the contact support 10.

If as in the case of FIG. 5, the measurements of thickness for the bottom 3a are not provided, of course, the first face 110 can be removed (the coverage structure 12 can thus be presented in other forms than those represented).

In a variant, the coverage structure 12 can be formed in several separate parts. Furthermore, the coverage structure 12 can optionally have one or several mobile parts to enable the positioning and the removal of the hollow container 3. In this case, the loading device 2 which holds the contact support 10 can be replaced by a static system. Although the forms of embodiment illustrated (particularly in FIG. 5) show that the positioning and the removal of the hollow container 3 are made possible by a complete release on the top and in the periphery of the hollow container 3 in a vertically inverted shape, it is understood that the relative mobility between the contact support 10 and the coverage structure 12 can be achieved in different ways (for example, with an assembly of two sections that are vertically superimposed, with only one of the sections which is vertically mobile, or by using a section which pivots against the other section).

Several sensor stations can be defined, with the option to simultaneously activate two mobile support members 21, 22, 23 for at least one of the stations. The control unit 6 can have connection interfaces IP1, IP2, IP3 with sensors for one same station, for example, to group together the measurements per station. FIG. 6 shows the mobile support members 23 connected to one same connection interface (here, the connection interface IP3 that can be seen in FIG. 1) can indicate several different positions simultaneously to reduce the calibration time. It is understood that the calibration can be achieved with several position detection phases by the position detection unit 5 (i.e. with a time difference between series of measurements, FIG. 6 typically illustrating a last detection phase, preceded by two other detection phases). This is permitted by the centralised command from the control unit 6. The breakdown into different detection phases can be the same in the actual measurement configuration.

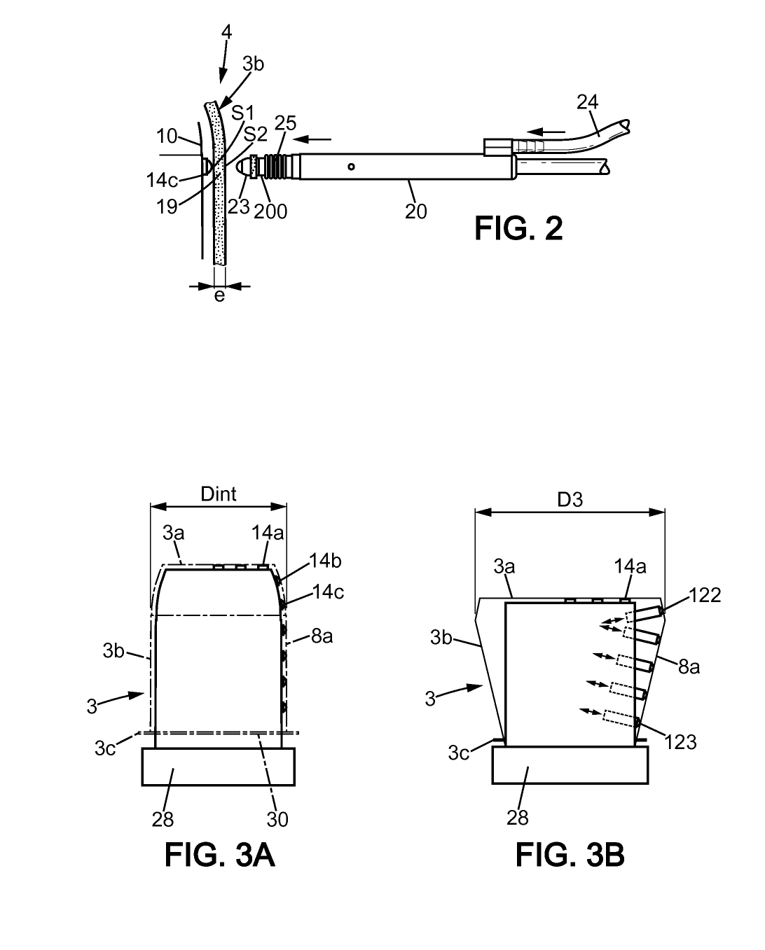

Now referring to FIG. 2, it can be seen that a pneumatic thrust is adapted for moving a mobile support member 23 up to a forward position in support contact with a face, here an external face, of the body 8 in an inspection area 19. For a hollow container 3 of plastic yogurt pot type, stretched by thermoforming, the thickness e that is measured can correspond to the accumulation of the thickness of an internal layer that includes gas, the thickness of a thinner internal crust and the thickness of an external crust, substantially as thin as the internal crust. Because of this wall structure, there is a risk of flattening the internal layer if the contact force of the mobile support member 23 exceeds a threshold.

With a thrust sensor, it is permitted to regulate the thrust force to not exceed such a threshold, for example, by having a thrust force less than 0.1 or 0.2 Newtons. A pneumatic metrology sensor is, for example, suitable. Similar pressurised air or liquid can thus be injected by a valve opening and circulate in a pipe 24 connected to a tube forming the guide 20. The channel defined by this guide 20 communicates with a pneumatic pressure source controlled by the control unit 6. An elastic return member 25, for example, in the form of a bellow, can be used to reduce the thrust force. As a non-exhaustive example, the mobile support member 23 can be located at the end of a measuring rod 200, which is held, by default, in a set-back position at least by the elastic return member 25 and slidably mounted into the guide 20. It is understood that the equipment 1 can be adapted for a great variety of walls (in opaque, transparent, compressible material).

Whereas in the calibration configuration, the mobile support member 23 is moved up to a first forward position defined by the stopper 14c, this is moved with a lesser amplitude in the actual measurement configuration, up to a second forward position, representative (compared with the first forward position) of the thickness e in the corresponding area of the section to inspect 8a.

According to the embodiment in FIGS. 1 and 6, nine mobile support members 21, 22, 23 are represented and configured to take measurements both for the bottom 3a and for the lateral wall 3b of the hollow container 3. More generally, a given number N of mobile support members 21, 22, 23 can be used, N being an integer higher than or equal to two, preferably higher than or equal to four. It is also understood that the equipment 1 can optionally perform measurements of thickness in the lateral wall 3b only, as illustrated in the variant in FIG. 5 (without sensors to measure the thickness in the bottom 3a).

Moreover, the equipment 1 can have a variable number of sensors, it can be configured with different distributions of sensors (optionally only to measure the bottom and/or to perform measurements in the sections to inspect, which are diametrically opposite each other, or angularly offset, by following an arrangement of stoppers 14a, 14b, 14c pre-positioned on the contact support 10).

As can be seen in FIG. 3A in particular, each one of the stoppers 14a, 14b, 14c can be pre-positioned according to the format of the section to inspect 8a of the body 8. Thus, without adjustment, the stoppers 14a, 14b, 14c, come into contact with the body 8 of the hollow container 3. It is understood that all the stoppers 14a, 14b, 14c, here in the form of static pads, are simultaneously in contact with the internal side of the section to inspect 8a, at least while the hollow container 3 is loaded in the actual measurement configuration. The contact support 10 can optionally include a peripheral part or a telescopic section which is moved during a prior configuration step, to conform with the profile of the section to be inspected 8a in the hollow container 3. Certain positional adjustments of the stoppers 14a, 14b, 14c can also be optionally provided by use of adjusting screws, before a very first measurement of thicknesses for a new format of hollow container 3.

Similarly, the orientation of the guides 20 is adapted according to the series of thicknesses to measure (series typically representative of a longitudinal profile of thicknesses). In other words, for a quality control application associated with a mass production of defined hollow containers 3, the stoppers 14a, 14b and 14c are already pre-positioned, the direction of the path of the mobile support members 21, 22, 23 is already defined in the alignment of the stoppers 14a, 14b, 14c, respectively opposite, and it is understood that no specific adjustment is required during production.

As can be seen in FIG. 5, to facilitate the positioning of the hollow container 3 and to ensure the correct positioning of this hollow container 3 in the predetermined space 4, the equipment 1 can have a mounting interface 28 which here comprises the loading device 2, one or several stopper bodies B1, B2 and position guiding elements. A gripping element 29 is provided on the loading device 2 to activate and manually move the contact support 10. In the represented example, the movement is a sliding movement on one or several rails R1, R2 or similar guiding means. Alternatively, this type of movement can be automated and initiated by activating a command, for example by pressing a button or screen area of the user interface 7 (or any other usual command for an HMI interface).

The mounting interface 28 is connected to the coverage structure 12 and here enables the contact support 10 to be moved by the intermediary of a sliding drawer 40 which forms the mobile part of the loading device 2. FIG. 5 illustrates the distant position of the sliding drawer 40 in relation to the coverage structure 12. The housing L defined under the arch of the coverage structure 12 is suitable to receive, typically with a small gap, the hollow container 3 inserted on the contact support 10.

The hollow container 3 can have an annular collar 3c connected to the body 8 and defining four sides. According to an alternative, the top end 3d has a perimeter of a determined format. The mounting interface 28 here has means to guide the hollow container 3 into position by one or several contacts on the side of the top end 3d, taking into account a perimeter format.

Guiding slots 41a, 41b or similar elements for guiding into position are provided in the mounting interface 28, here close to the measuring area of the coverage structure 12. Additional guiding elements 42a, 42b are provided on either side of the contact support 10, on a top face 42 of the drawer 40.

It is understood that the collar 3c which here defines a maximum perimeter of the hollow container 3 can be blocked in rotation between the guiding elements 42a, 42b, at the time of the positioning of the hollow container 3 on the contact support 10. Indeed, the gap between the faces opposite the guiding elements 42a, 42b can correspond to a first size of the collar 3c. Then, during the movement of both the contact support 10 and the hollow container 3 towards the coverage structure 21 to obtain the actual measurement configuration, a centring in the housing L is enabled by the insertion of two opposite edges of the collar 3c in the guiding slots 41a, 41b. Such edges can optionally be straight-lined, which enables, for example, packs of hollow containers 3 with a straight-lined separable junction to be achieved between the collars 3c of two containers adjacent in the pack. This enables rows of containers to be formed, and facilitates the purchase of a plurality of products, for example food products, packaged using hollow containers 3.

The sliding drawer 40 comes to be pressed on the stopper body B2 to block a proximal position of the contact support 10 in relation to the coverage structure 12. With such a blockage, it is ensured that the predetermined space 4 remains identical from one measurement to another. Optionally, an auxiliary stopper (not represented), for example, formed by a mobile projection, can be provided to prevent any return of the sliding drawer 40 towards a distant position as shown in FIG. 5, so that the hollow container 3 is held in a set position in the housing L. A stopper body B1 can also be formed on the mounting interface 28 to limit the path of the sliding drawer 40 in the direction opposite to the housing L.

Of course, the path and the positioning of the contact support 10 in the housing L can be identical to achieve the calibration configuration, without the hollow container 3.

In the non-exhaustive example in FIG. 5, the contact support 10 can form a protruding projection from the top face 42, by defining a height h1 different from the height h3 of the container 3, for example higher, in order to avoid any disturbing contact between the top end 3d of the hollow container 3 (which here is located in an inverted shape) and the top face 42. Also, the body 8 of the hollow container 3 is preferably brought and positioned in a non-surrounded state in the predetermined space 4 between the contact support 10 and the coverage structure 12, in order to avoid any deformation of the section of wall 8a to inspect.

Now in reference to FIG. 3B, it is described an embodiment of the method for measuring thicknesses, which suits hollow containers 3 for which the characteristic size (diameter Dint as can be seen in FIG. 3A) of the axial opening 30 is less than a maximum diameter D3 or similar size of the lateral wall 3b.

The embodiment in FIG. 3B shows the mobile support members 122, 123 located on the internal side of the hollow container 3, at least for measurements of thickness which relate to the lateral wall 3b in this example. The mounting of sensors is thus inverted, at least for part, compared with the case illustrated in FIGS. 1 and 3A. Bodies 8 with a section enlargement by moving closer to the bottom 3a can thus be positioned on a contact support 10, using a set-back, non-protruding position from the mobile support members 122, 123. After the positioning on the contact support 10 and achieving the actual measurement configuration, the mobile support members 122, 123 are moved towards the predetermined space 4 and come into contact with the section to inspect 8a. In this case, the stoppers 14b and 14c can be formed on the coverage structure 12 by the outside. The structure 12 has a predefined conformation of stoppers 14b and 14c, which are, for example, static and whereon the section to inspect 8a comes to be coupled at the end of loading the hollow container 3. The calibration principle remains the same, knowing that:
the contact support 10 and the static stoppers 14a formed at the free end 10a of this contact support 10 are positioned identically between the calibration configuration and the actual measurement configuration; and
the other static stoppers 14b, 14c connected to the coverage structure 12 are positioned identically between the calibration configuration and the actual measurement configuration.

Alternatively, the coverage structure 12 can be similar to the example in FIG. 1, apart from the geometric adaptation to the profile of the section to inspect 8a. More generally, it is understood that there is not necessarily any need to resort to static stoppers 14b, 14c, for all or part of the measurements of thickness of the lateral wall 3b. This is the same for measurements of thickness relating to the bottom 3a.

In variants, for a hollow container 3 such as shown in FIG. 3B, a mobile part of the mounting interface 28 can be used to move the arch or similar measuring part of the coverage structure 12, while the contact support 10 remains static. More generally, it is understood that what has been defined for the mounting interface 28 or parts of this in reference to FIGS. 1 and 5-6 can be applied for hollow containers 3 of a different format, by means of simple geometric adaptations of the contact support 10 and/or the coverage structure 12.

An example of executing a measuring method that conforms with the invention, in a context of quality control of a method for manufacturing hollow containers 3, will now be defined in reference to FIGS. 1 and 4-6.

As can be seen in FIG. 4, during a functioning 51 of a production line of several hollow containers 3, a step 52 for recovering a hollow container forming a sample is carried out for recovering a hollow container 3 in an unfilled state. When the body 8 of the hollow container 3 is obtained from a step 51a for forming from plastic material, it is understood that the recovery step 52 is carried out after this forming step 51a.

In this last case, the plastic material used, in particular when the hollow container 3 defines a yogurt pot, can be transparent or not. It is also understood that the hollow container 3 can be achieved by thermoforming, blow moulding extrusion, injection blow moulding, or other similar method enabling forming through stretching the plastic material. The axial opening 30 is wide as is usually understood by a person skilled in the art, in other words, it is not as narrow as a neck opening and is unsuitable for pouring a liquid content precisely (it is thus well-known that yogurt pots, beakers, cups, paint pots and containers of the same type have a wide opening).

The hollow container 3, optionally provided with a collar 3c at its top end 3d, can have an external surface section 31 adapted for receiving a decorative and/or protective layer, for example, in the form of a label, a sticker or similar element. Here, the case of a hollow container 3 which has not been covered by this type of layer is interesting. However, the method is adapted for enabling measurements of thicknesses after being covered by a label or similar layer, either because this layer is removed (for example, by an intermediary treatment with steam), or because information regarding thickness distribution is wanted for a hollow container 3 covered by such a layer.

Optionally, the lateral wall 3b can have a cylindrical external surface section 31 and/or a conic or curved longitudinal external surface section 32. Of course, the guides 20 are mounted so as to take into account possible section variations in the lateral wall 3b. In the same way, the bottom 3a can have an indentation as illustrated in FIG. 5 and it is understood that the stoppers 14a are pre-positioned by taking into account the possible level differences of the surfaces to insert.

The calibration step 53 can be carried out before or during the recovery step 52. It is understood that it is about achieving zero for each one of the sensors, which will enable the difference in movement to be measured for each support member 21, 22, 23 compared with zero. A prior positioning step 50 can be provided to bring the contact support 10 and the coverage structure 12 into the calibration configuration. The mounting interface 28, here with the sliding drawer 40, enables this prior positioning step 50 to be carried out. Then, the calibration step 53 is initiated, for example, by selecting a corresponding command on the command touchscreen 7a. As can be seen in FIG. 6, the mobile support members 22, 23 can be moved according to separate movement phases.

Thus, in reference to FIGS. 1 and 6, a first movement phase 53a can involve the first support members 21 (which here are intended to be pressed down on the bottom 3a and are moved vertically, parallel to the longitudinal axis Z of the contact support 10, except for in cases where the inspected bottom surfaces are tilted). With a time difference compared with this first phase, a second movement phase 53b can involve the second support members 22 which are moved along a direction transversal to the longitudinal axis Z are intended to be pressed down on the lateral wall 3b. Similarly, a third movement phase 53c is carried out in the way illustrated in FIG. 6, by moving the third support members 23. Each one of these movements enables positional information to be recovered for the respective facing stopper 14a, 14b and 14c (detection of the first forward position of the mobile support member in question).

In reference to FIG. 4, the recovered hollow container 3 is to be used and moved in the following way:
a step 54 for installing the hollow container on the mounting interface 28 is carried out when the contact support 10 is distant from the coverage structure 12, by bringing the hollow container 3 into a position slotted onto the contact support 10, preferably with a rotating adjustment using guiding elements 42a, 42b;
a positioning step 55 is then carried out by relative movement between the contact support 10 and the coverage structure 12, here by moving the hollow container 3 to the slotted state into the housing L, without handling the contact support 10 (the gripping element 29, for that, being set back on an end of the sliding drawer 40 opposite the static structure 12), preferably by centring the hollow container 3 using guiding elements 41a, 41b.

The actual measurement configuration illustrated in FIG. 1 is thus obtained from this step 55, in this example by inserting the sliding drawer 40 on the stopper body 42. It can be noted that from the operator's point of view, the positioning step 55 (with the hollow container 3 already loaded) can be completely similar to the positioning step 50.

Then, by keeping the actual measurement configuration, a step (56, 56, 58) for inspecting the recovered hollow container 3 can be triggered, during which the measurements of thickness are taken. For this, as for the calibration step 53, the movements of different mobile support members 21, 22, 23 are controlled. Thus, the second forward position of the mobile support member in question is detected (it should be noted that in a variant, the calibration step 53 can be carried out a little after the inspection step (56, 57, 58)).

The movements here are automatic and therefore a complete measuring step 56 can be carried out through position detection, with the automatic determination of several thicknesses. This step 56 can be subdivided into different sub-steps 56a, 56b, 56c, with typically simultaneous movements of mobile support members 21, 22 or 23 connected to one same connection interface IP1, IP2 or IP3, respectively. In practice, in a preferred embodiment, the steps 56a, 56b, 56c can be activated and succeed each other identically or completely similarly to what is carried out for the steps 53a, 53b, 53c.

In variants of the measurement method, more measurements of thickness can be obtained, for example, by pivoting a predefined angle (for example, between 5 or 10° and 90° and/or around 180°), the hollow container 3 in relation to the contact support 10, around the longitudinal axis Z. In this case, the rotation of the contact support is achieved between two complete cycles which enable each one to succeed at the data recovery step 57. A calibration step is preferably carried out both for the cycle which precedes the rotation and for the following cycle. When the guiding elements 41a, 41b, 42a, 42b cooperate with a collar 3c of the container 3 which has four straight-lined edges forming a virtual square, it is preferable to turn the container 3 around the longitudinal axis Z by +90°, −90°, 180° or a combination of these options.

When the position detection unit 5 has finished moving the mobile support members 21, 22, 23, a display modification can be made with the interface 7 and an unloading can be carried out, for example, by pulling back the gripping body 29. Automatically, the control unit 6 processes the data collected by the sensors. The screen 7b can display, in real time, the information representing the measured thicknesses. It is understood that the data recovery step 57, obtained here by the intermediary of the connection interfaces IP1, IP2 and IP3 or other suitable connection, is quick and the operator can immediately view the thickness distribution results for the hollow container 3 which has just been inspected.

In an embodiment, each thickness e that has just been measured is subject, during a control step 58, to being compared with one or several predefined thresholds configured on the equipment 1. A calculation routine thus enables the information regarding thickness to be displayed in a specific way, when it is outside of the desired range. Optionally, when at least one thickness e measured for the recovered hollow container 3 is outside of a range limited by the predefined threshold(s), an adjustment step 59 of the forming step 51a and/or a step prior to the forming step 51a is carried out.

The step for adjusting one or several manufacturing parameters is carried out according to the difference (excess or insufficient thickness) detected during the control step 58. Thus, the hollow containers 3 manufactured later can have a body 8 that has at least one thickness modified in relation to the recovered body that has been inspected according to the measuring method.

As a non-exhaustive example, if a lack of material is observed at the bottom 3a of the container 3, an increase in setpoint temperature at the heating step can be carried out during thermoforming. An alternative or additional option can be to modify the relative distance between the bottom of the mould and the stamp (more specifically, to reduce it) when this finishes its course.

In the event of a difference in thickness observed between two faces or areas opposite the lateral wall 3b, a re-centring of the thermoforming stamp will typically be carried out.

The method also enables a significant modification in the overall form of the thickness distribution curve to be detected as early as possible, so that maintenance corresponding to the renewal of stamps can consequently be planned.

Independently from the type of sensors used to obtain measurement data, it can be noted that using a loading device 2 has advantages to block, in the same place, a contact support 10 which is inserted in the internal volume of the hollow container 3. It is thus ensured, that the position remains unchanged between the calibration step 53 and the measuring step 56.

One of the advantages of the invention resides in the fact of being able to guarantee a pot or similar container quality more easily for consumers, which enables the containers 3 to be of reduced weight. The measurements are taken without radiation or electrical discharge in the predetermined space 4 serving to receive the section to inspect 8a, which makes the method suitable for a wide range of walls.

With a pre-positioning of a sliding guide 20 for each sensor, it is ensured that the direction of movement is truly perpendicular to the surface area targeted for an effective measurement of thickness. Thus, any uncertainty linked to handling by an operator is erased.

It must be obvious for persons skilled in the art, that this invention enables embodiments in many other specific forms, without moving away from the scope of the invention as claimed. In particular, the invention is not limited to applications for measuring containers that have a circular opening. It is understood that for an oval opening, or form close to a square, the diameter Dint can be replaced by a similar, characteristic size. The contact support 10 can thus have at least opposite contact surfaces and/or form a stamp for all or part of the internal face of the container 3 (in terms of generators), which enables a suitable positioning of this container 3.

The containers 3 can correspond to a capacity of 25 to 500 g, preferably 75 to 200 g of food content. In this case, the height h3 is typically between 40 and 200 mm, preferably between 50 and 120 mm and typically with an axial opening 30, of which the width or the diameter Dint is more than or equal to half the diameter (or similar size) of the bottom 3a. However, the measuring method is also suitable for containers of different capacities, for example, around 1000 g or more.

1-16. (canceled)

17. A method for measuring thickness in at least one section to inspect of a body of a hollow container, the body defining an internal volume leading to an axial opening, the method comprising:
recovering the hollow container, the body of the recovered hollow container comprising a bottom opposite the axial opening and defining a lateral wall which extends around a longitudinal axis (A);
in a contacting step, contacting the bottom and/or an internal face of the lateral wall with a contact support which fills all or part of the internal volume;
determining a thickness respectively in N separate areas which are part of the section to inspect, by using N mobile support members that are each guided by a set orientation guide positioned in one among the contact support and an exterior coverage structure that covers the hollow container, the N mobile support members being each slid into the guide towards:
i) a first contact surface defined by a stopper intended to be in contact with the body of the hollow container in a calibration configuration without the hollow container, the calibration configuration being obtained before or after the contacting step, so as to detect a first forward position of the mobile support member in question;
ii) a second contact surface defined by the body of the hollow container, in an actual measurement configuration, when the body of the hollow container is again in contact with the contact support, so as to detect a second forward position of the mobile support member in question, the second forward position being representative of a thickness of the body of the hollow container compared with the first forward position;
performing automatic control of the movement of the N mobile support members by a control unit, N being an integer higher than or equal to two.

18. The measuring method according to claim 17, wherein the N mobile support members are each moved under the effect of a pressurised fluid and each exerting a contact force on the body of the container, regulated by:
an elastic return member; and/or
a device for regulating the pressurising of the pressurised fluid;
the section to inspect being made from a flexible material.

19. The measuring method according to claim 17, wherein the hollow container, which has no neck, has a height measured longitudinally between the bottom and a top end, measurements of thickness of the hollow container being taken at different height levels by all or part of the N mobile support members.

20. The measuring method according to claim 17, wherein N is an integer higher than or equal to five, a first phase for detecting the second forward position being carried out simultaneously for at least two areas belonging to the bottom, by simultaneously moving at least two first mobile support members from the N mobile support members.

21. The measuring method according to claim 20, wherein mobile support members from the N mobile support members, separate from the first mobile support members, are moved to carry out at least one other phase for detecting the second forward position for one or several areas belonging to the lateral wall, at least one of the N mobile support members being moved with a time difference in relation to the movement of the first mobile support members.

22. A method for manufacturing hollow containers provided with a body intended to be filled by a content, comprising a step for forming the body by defining an internal volume leading to an axial opening, and wherein measurements of thickness of the body are taken in different areas of said body, by following the method for measuring the thickness according to claim 17, the manufacturing method comprising:
a step for recovering a hollow container after the forming step;
a step for inspecting the recovered hollow container, during which said measurements of thickness are taken, comprising a control of the measurements of thickness according to one or several predefined thresholds;
when at least one thickness measured of the body of the recovered hollow container is outside of a range limited by said threshold(s), an adjustment step of the forming step and/or a step prior to the forming step, in order to manufacture hollow containers, of which the body has at least one thickness modified as compared as thickness of the body of the recovered container.

23. A measuring equipment for measuring thickness for the implementation of the measuring method according to claim 17, enabling measurements of the thickness of a hollow container that has a body with a determined format provided with a bottom and a lateral wall, the measuring equipment comprising:
a contact support intended to be slotted into the internal volume of the hollow container, the contact support having a free end; and
a position detection unit comprising at least one mobile support member which is:
i) mobile up to a first forward position defined by a stopper in a calibration configuration of the measuring equipment; and
ii) adapted for bearing, in an actual measurement configuration of the measuring equipment, against the body of the hollow container, so as to define a second forward position that is representative of a thickness of the body of the hollow container when compared with the first forward position;
a coverage structure which defines with a contact support, a predetermined space in the calibration configuration and the actual measurement configuration, the predetermined space being intended to receive a section to inspect of the body of the hollow container, in the actual measurement configuration when the body of the hollow container is slotted onto the contact support,
wherein the position detection unit comprises:
a number N of mobile support members each guided by a set orientation guide positioned in one among the contact support and the coverage structure, each one of the N mobile support members being slid into the guide towards the predetermined space in the calibration configuration and in the actual measurement configuration;
a same number N of stoppers corresponding to the path of said N mobile support members to respectively define said first forward position; and
a control unit to automatically control the movement of the N mobile support members, N being an integer higher than or equal to two.

24. The Measuring equipment according to claim 23, wherein one of the N mobile support members is positioned at a greater distance from the free end of the contact support than another of the N mobile support members.

25. The measuring equipment according to claim 23, wherein the coverage structure has a first face which extends parallel to a first plane to cover an external face of the bottom and a second face which extends from an end close to or connected to the first face, up to a section distant from the first plane, a mobile determined support member from the mobile support members being configured to slide along a direction perpendicular to the first plane and to enable a measurement of the thickness of the bottom, the free end of the contact support having a determined stopper, among the N stoppers, which corresponds to the path of the determined support member to define the first forward position of the determined support member.

26. The measuring equipment according to claim 23, wherein two of the N stoppers are static and pre-positioned according to the determined format of the body of the hollow container, so that each one of these two stoppers forms a localised support in said section to inspect.

27. The measuring equipment according to claim 23, wherein the control unit is configured to simultaneously control the movement of at least one of the N mobile support members, respectively in the calibration configuration and in the actual measurement configuration.

28. The measuring equipment according to claim 23, comprising a mounting interface provided with a stopper body and connected to the coverage structure, the mounting interface being configured to move the contact support between a position distant from the coverage structure and a proximal position, the calibration configuration and the actual measurement configuration being obtained when the contact support is in said proximal position, the contact support being blocked in the proximal position by the stopper body.

29. The measuring equipment according to claim 28, wherein the hollow container has an annular collar connected to the body and defining four sides, the mounting interface having at least two positional guiding elements to guide at least two opposite sides of the four sides of the collar.

30. The measuring equipment according to claim 23, wherein each one of the N mobile support members comprises a measuring rod mounted sliding into a guide communicating with a pneumatic pressure source controlled by the control unit.

31. The measuring equipment according to claim 23, wherein the N mobile support members are spread out in one same longitudinal plane parallel to a longitudinal axis of the hollow container in the actual measurement configuration.

32. The measuring equipment according to claim 23, wherein each set orientation guide is mounted in the coverage structure which forms an arch.

33. The measuring equipment according to claim 28, wherein the mounting interface is provided with a sliding drawer, the contact support being moved by the sliding drawer.
